(19) United States
(12) Patent Application Publication
(10) Pub. No.: US 2014/0244506 A1
(43) Pub. Date: Aug. 28, 2014

(54) DYNAMIC PAYMENT AUTHORIZATION SYSTEM AND METHOD

(71) Applicant: EURONET WORLDWIDE, INC., LEAWOOD, KS (US)

(72) Inventor: RICHARD GRAMLING, OLATHE, KS (US)

(73) Assignee: EURONET WORLDWIDE, INC., LEAWOOD, KS (US)

(21) Appl. No.: 14/194,337

(22) Filed: Feb. 28, 2014

Related U.S. Application Data
(60) Provisional application No. 61/770,845, filed on Feb. 28, 2013.

(51) Int. Cl. G06Q 20/40; G06Q 20/36

(52) U.S. Cl. CPC G06Q 20/40; G06Q 20/36
USPC 705/44; 705/41

(57) ABSTRACT

A computer program, system, and method for facilitating payment processing, including requesting authorization information from a user, with the authorization information confirming that the user intends to complete a payment transaction at a payment terminal. After initial authorization information is received, transaction information is received, with the transaction information being indicative of the payment transaction being initiated at the payment terminal. Finally, the authorization information is compared with transaction information, and based on the result of the comparison, the payment transaction is either allowed or disallowed.

### FIELD

This non-provisional application claims priority to co-pending U.S. Provisional Patent Application Ser. No. 61/770,845, filed on Feb. 28, 2013, the entire disclosure of which is incorporated herein by reference.

### FIELD

Embodiments of the present invention are broadly directed to the field of payment processing. More particularly, embodiments of the present invention relate to a computer program, a system, and a method of electronic payment processing that dynamically links a funding account and/or a mobile wallet to a physical payment instrument (e.g., a payment card) that can be processed by standard point-of-sale payment terminals.

### BACKGROUND

Payment instruments (i.e. credit cards, debit cards, charge cards, prepaid cards, gift cards, stored-value cards, fleet cards, etc.) have long been important to and widely used by consumers as a system of processing payments for purchase of goods and/or services. In a typical payment instrument transaction, when it is time to pay for the goods/services, a merchant will total up the purchase amount at the point-of-sale (POS) register or other merchant payment terminal, and the customer will slide his/her payment card through the register card reader to initiate the transaction. Additional customer confirmation, such as a PIN number, may be required to proceed with the transaction. This information is usually input by the customer using a keypad located on the merchant's register. The payment transaction information, including such information as transaction amount, customer account number, customer PIN number, etc., is transmitted electronically from the payment terminal to the merchant acquirer's processor (an entity that processes and settles the merchant's payment card transactions with the merchant's acquiring bank), and then is routed electronically from the merchant acquirer's processor to the customer's bank or financial institution (i.e. the card issuer) via the card issuer's payment network (e.g., VISA™, MASTERCARD™, etc.). An authorization code is then sent from the card issuer to the merchant acquirer's processor (if there is valid credit/funding available) and the merchant acquirer's processor sends authorization for the transaction back to the payment terminal and the customer receives the purchased goods/services.

The funds for the payment instrument transaction are then electronically transferred from the customer's financial institution to the merchant's acquiring bank account through the payment network. This is usually accomplished through a daily batch process in which a merchant submits all transaction information for transactions that have been authorized throughout the day to the acquirer bank (or the acquirer processor) in one batch. The batch is sent through the payment network for distribution to the appropriate issuer(s), and the appropriate payment is routed through the payment network to the acquirer bank. Similar processes are currently used for virtually all POS transactions, including credit/debit/prepaid card purchases and ATM withdrawals.

In recent years mobile payments have become increasingly more popular for many consumers as an alternative to standard payment instruments (i.e., cash, checks, payment cards, etc.). Instead of paying with cash, check, or credit cards, a consumer can use a mobile phone to pay for a wide range of goods and/or services. Such mobile payments provide a number of advantages that are not typically achievable through the use of payment cards. For example, mobile payments typically are much more secure than standard payment cards, which particularly in the U.S. are subject to simple fraudulent use. All that is needed to access a consumer's account and/or funds is to possess either the payment card or the payment card information (e.g. Cardholder Name, Primary Account Number or PAN, expiration date, and security code such as CV2). Merchant's and banks endure constant losses due to chargebacks and theft. Consumers are faced with the risk and inconvenience of these fraudulent charges. Moreover, standard payment cards are inconvenient to consumers because they are not given the ability to control when and who can spend funds from their accounts. It is not possible to control authorization on a per transaction basis.

In the future, mobile devices may displace payment cards as the preferred option for convenient electronic payments. This is already proven in emerging international markets where limited existing electronic payment infrastructure is easily displaced by mobile device based solutions. In mature markets, however, consumer adoption has been slower as traditional retailers (e.g. non-online, “brick and mortar” retails) make necessary investments in their point-of-sale technology. Current mobile payment solutions generally require traditional retailers to buy and integrate new hardware and/or software. Thus, while mobile payments are expected to grow rapidly, it will take years before most traditional retail locations are provisioned to accept mobile contactless or other existing mobile payment solutions.

Therefore, it would be beneficial to provide a mobile payment solution that allows merchants to accept mobile transactions utilizing standard payment instrument technology and/or without requiring significant investment in new point-of-sale technology.

### SUMMARY

Embodiments of the present invention include a computer program, a system, and a method for facilitating payment processing. Embodiments include the initial step of generating a user interface displayable on a display of a user's computing device. A next step includes requesting, via the user interface, authorization information from the user, with the authorization information comprising information that confirms that the user intends to complete a payment transaction at a payment terminal. Thereafter, the authorization information is received from the user. In addition, embodiments provide for transaction information to be received, with the transaction information being indicative of the payment transaction being initiated at the payment terminal. Finally, the authorization information is compared with the transaction information, and based on the result of the comparison the payment transaction is either allowed or disallowed.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic illustration of a system for facilitating payment processing according to embodiments of the present invention;

FIG. 2 is a flowchart of a process for facilitating payment transactions from a computing device according to embodiments of the present invention; and

FIG. 3 is a method for facilitating payment transactions according to embodiments of the present invention.

FIG. 4 is an illustration of a sign in/registration screen of a mobile “app” of an embodiment of the present invention.

FIG. 5 is an illustration of a mobile wallet of the mobile “app” of FIG. 4, showing the mobile wallet without any funding accounts yet added to the wallet.

FIG. 6 is an illustration of the mobile wallet of FIG. 5 showing the addition of a new funding account to the wallet.

FIG. 7 is an illustration of the mobile wallet of FIG. 6 after the funding account has been added to the wallet and is ready for use in the mobile “app”.

FIG. 8 is an illustration of the mobile “app” of FIG. 4, showing a QR code being scanned to initiate a payment transaction, and also showing additional user options for initiating a transaction at a merchant payment terminal.

FIG. 9 is an illustration of the mobile “app” of FIG. 4, in which identification of a merchant terminal is confirmed by the user before a transaction is initiated at the terminal and a transaction amount is ultimately authorized by the user. In FIG. 9, a log of recent prior purchases utilizing the mobile “app” is also shown.

FIG. 10 is an illustration of the mobile “app” of FIG. 4 showing a transaction amount authorization request screen that is generated on the mobile “app” after the transaction has been initiated at the merchant terminal.

FIG. 11 is the transaction amount authorization request screen of FIG. 10 after a user has added a tip via an automated tip calculator selection option.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, various embodiments of the present technology include a variety of combinations and/or integrations of the embodiments described herein.

### System Description

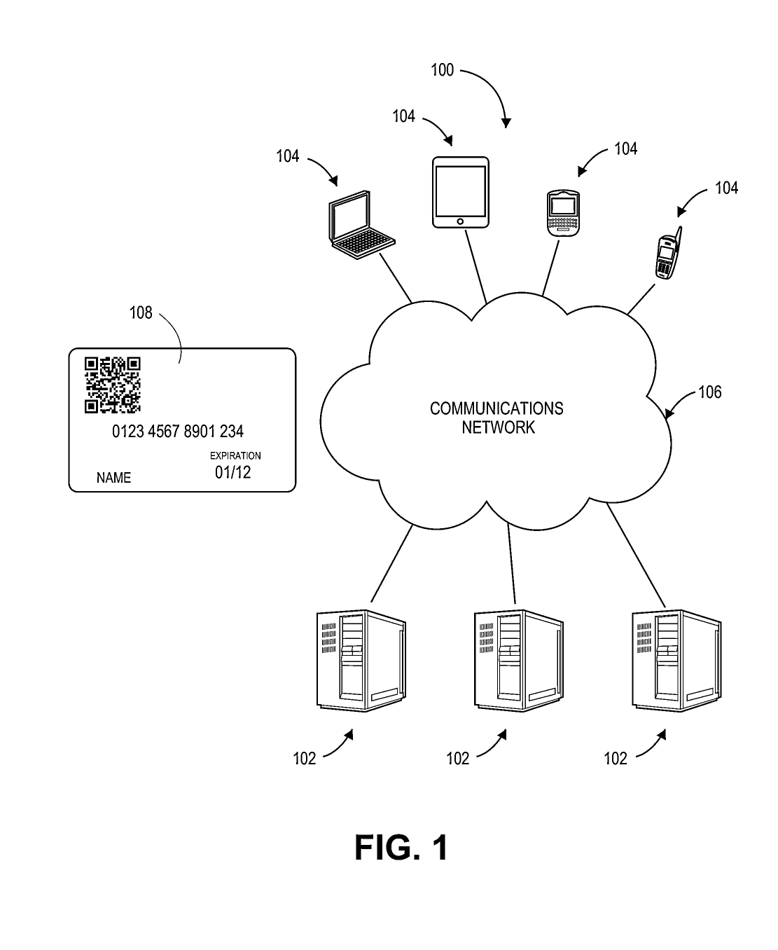

Various embodiments of the computer program, system, and method of embodiments of the present invention are implemented in hardware, software, firmware, or combinations thereof using the mobile payment system 100, shown in FIG. 1, which broadly comprises server devices 102, computing devices 104, a communications network 106, and a payment instrument 108. Various embodiments of the server devices 102 include computing devices that provide access to one or more general computing resources, such as Internet services, electronic mail services, data transfer services, and the like. In some embodiments the server devices 102 also provides access to a database that stores information and data, with such information and data including, without limitation, payment instrument information (e.g. Cardholder Name, primary account number (PAN), expiration date, security codes, or the like) related to payment instruments 108, consumer user information (e.g., consumer name, funding account/mobile wallet information, passwords/PINS, or the like), or other information and data necessary and/or desirable for the implementation of the computer program, system, and method of the present invention, as will be discussed in more detail below.

Various embodiments of the server devices 102 and the computing devices 104 include any device, component, or equipment with a processing element and associated memory elements. In some embodiments the processing element implements operating systems, and in some such embodiments is capable of executing the computer program, which is also generally known as instructions, commands, software code, executables, applications (apps), and the like. In some embodiments the processing element includes processors, microprocessors, microcontrollers, field programmable gate arrays, and the like, or combinations thereof. In some embodiments the memory elements are capable of storing or retaining the computer program and in some such embodiments also store data, typically binary data, including text, databases, graphics, audio, video, combinations thereof, and the like. In some embodiments the memory elements also are known as a “computer-readable storage medium” and in some such embodiments include random access memory (RAM), read only memory (ROM), flash drive memory, floppy disks, hard disk drives, optical storage media such as compact discs (CDs or CDROMs), digital video disc (DVD), Blu-Ray™, and the like, or combinations thereof. In addition to these memory elements, in some embodiments the server devices 102 further include file stores comprising a plurality of hard disk drives, network attached storage, or a separate storage network.

Various embodiments of the computing devices 104 specifically include mobile communication devices (including wireless devices), work stations, desktop computers, laptop computers, palmtop computers, tablet computers, portable digital assistants (PDA), smart phones, wearable devices and the like, or combinations thereof. Various embodiments of the computing devices 104 also include voice communication devices, such as cell phones or landline phones. In some preferred embodiments, the computing device 104 has an electronic display, such as a cathode ray tube, liquid crystal display, plasma, or touch screen that is operable to display visual graphics, images, text, etc. In certain embodiments, the computer program of the present invention facilitates interaction and communication through a graphical user interface (GUI) that is displayed via the electronic display. The GUI enables the user to interact with the electronic display by touching or pointing at display areas to provide information to the user control interface, which is discussed in more detail below. In additional preferred embodiments, the computing device 104 includes an optical device such as a digital camera, video camera, optical scanner, or the like, such that the computing device can capture, store, and transmit digital images and/or videos.

In some embodiments the computing devices 104 includes a user control interface that enables one or more users to share information and commands with the computing devices or server devices 102. In some embodiments, the user interface facilitates interaction through the GUI described above or, in other embodiments comprises one or more functionable inputs such as buttons, keyboard, switches, scrolls wheels, voice recognition elements such as a microphone, pointing devices such as mice, touchpads, tracking balls, styluses. Embodiments of the user control interface also include a speaker for providing audible instructions and feedback. Further, embodiments of the user control interface comprise wired or wireless data transfer elements, such as a communication component, removable memory, data transceivers, and/or transmitters, to enable the user and/or other computing devices to remotely interface with the computing device 104.

In various embodiments the communications network 106 will be wired, wireless, and/or a combination thereof, and in various embodiments will include servers, routers, switches, wireless receivers and transmitters, and the like, as well as electrically conductive cables or optical cables. In various embodiments the communications network 106 will also include local, metro, or wide area networks, as well as the Internet, or other cloud networks. Furthermore, some embodiments of the communications network 106 include cellular or mobile phone networks, as well as landline phone networks, public switched telephone networks, fiber optic networks, or the like.

Various embodiments of both the server devices 102 and the computing devices 104 are connected to the communications network 106. In some embodiments server devices 102 communicate with other server devices 102 or computing devices 104 through the communications network 106. Likewise, in some embodiments, the computing devices 104 communicate with other computing devices 104 or server devices 102 through the communications network 106. In various embodiments, the connection to the communications network 106 will be wired, wireless, and/or a combination thereof. Thus, the server devices 102 and the computing devices 104 will include the appropriate components to establish a wired or a wireless connection.

Embodiments of the payment instrument device 108 include any type of payment instrument device used to conduct payment transactions. For instance, in some embodiments the payment instrument device 108 is a payment card (i.e., a credit card, debit card, charge card, prepaid card, gift card, stored-value card, fleet cards, etc.) with a magnetic stripe that stores the payment card information (e.g. cardholder name, PAN, expiration date, security codes, etc.). In other embodiments, the payment instrument device 108 is a contactless payment device, such as a near field communications (“NFC”) device or a Bluetooth™ enabled device.

Various embodiments of the computer program of the present invention run on computing devices 104. In other embodiments the computer program runs on one or more server devices 102. Additionally, in some embodiments a first portion of the program, code, or instructions execute on a first server device 102 or a first computing device 104, while a second portion of the program, code, or instructions execute on a second server device 102 or a second computing device 104. In some embodiments, other portions of the program, code, or instructions execute on other server devices 102 as well. For example, in some embodiments information is stored on a memory element associated with the server device 102, such that the information is remotely accessible to users of the computer program via one or more computing devices 104. Alternatively, in other embodiments the information is directly stored on the memory element associated with the one or more computing devices 104 of the user. In additional embodiments of the present invention, a portion of the information is stored on the server device 102, while another portion is stored on the one or more computing devices 104. It will be appreciated that in some embodiments the various actions and calculations described herein as being performed by or using the computer program will actually be performed by one or more computers, processors, or other computational devices, such as the computing devices 104 and/or server devices 102, independently or cooperatively executing portions of the computer program.

A user is capable of accessing various embodiments of the present invention via an electronic resource, such as an application, a mobile “app,” or a website. In certain embodiments, portions of the computer program are embodied in a stand-alone program downloadable to a user's computing device 104 or in a web-accessible program that is accessible by the user's computing device 104 via the network 106. For some embodiments of the stand-alone program, a downloadable version of the computer program is stored, at least in part, on the server device 102. A user downloads at least a portion of the computer program onto the computing device 104 via the network 106. After the computer program has been downloaded, the program is installed on the computing device 104 in an executable format. For some embodiments of the web-accessible computer program, the user will simply access the computer program via the network 106 (e.g., the Internet) with the computing device 104.

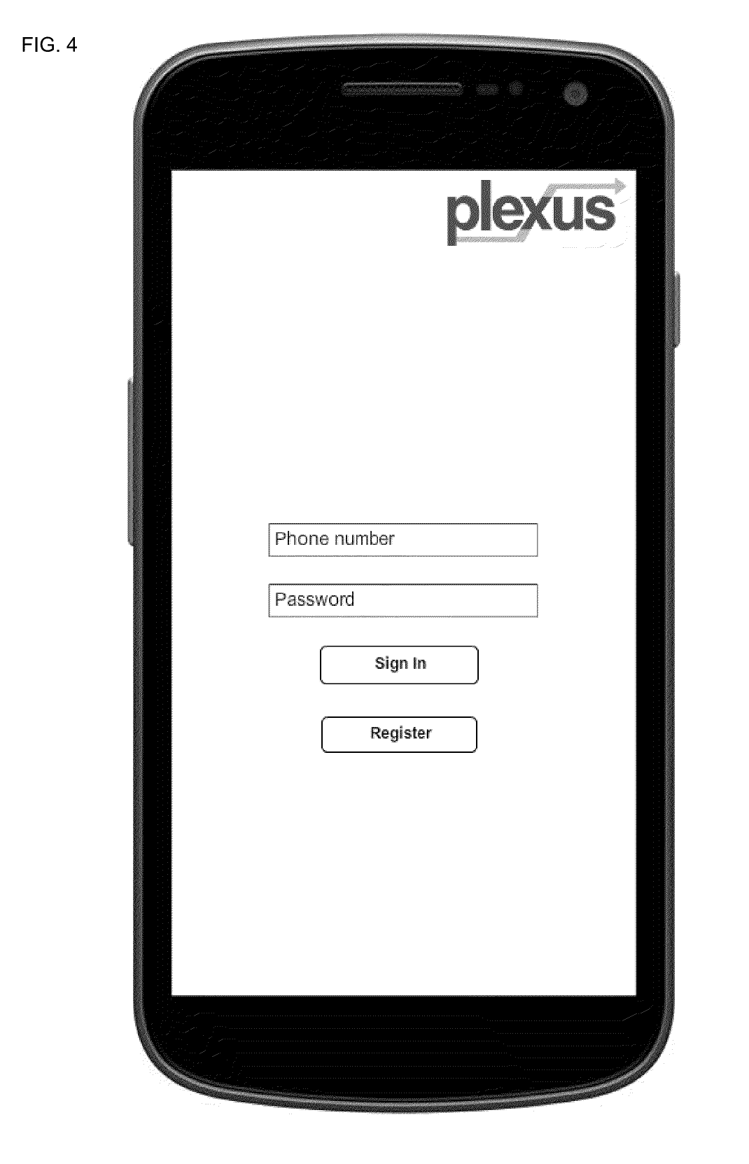

Referring to FIG. 4, a sign in and registration screen is shown of an embodiment of a mobile “app” of the instant invention. Once the consumer user has access to the electronic resource (i.e., the mobile “app” or the website) via the computer program installed on a user's computing device 104 or the web, certain embodiments provide for the user to create an account with which to further access and implement the electronic resource. To create an account, the consumer user may be required to input information related to the consumer user, such as the consumer user's name, address, date of birth, tax identification number (i.e., SSN), or the like. In some embodiments, the consumer account will further be associated with a funding account. Embodiments provide for the funding account to be any type of financial account, such as a checking account, savings account, pooled account, prepaid account, credit account, debit account, crypto-currency wallets or other similar financial accounts. Regardless of the type of account, the funding account is associated with a mobile wallet, which is a virtual representation of the funding account that is accessible via the consumer account of the electronic resource of embodiments of the present invention. In some additional embodiments, the consumer account will be associated with multiple funding accounts and/or mobile wallets. In various embodiments, the information related to the consumer user will be stored within the memory elements of the computing device 104, the server 102, and/or in the associated database. In addition, the consumer user will in some embodiments be required to choose, or will be given, login information, such as a username and a password/PIN with which to access the user account via the electronic resource.

In addition, various embodiments of the present invention include any number and/or any specific types of account as may be necessary and/or desirable to carry out the functions, features, and/or implementations of the present invention.

### Operation

Embodiments of the present invention provide a computer program, system, and method for facilitating mobile payments by dynamically linking a funding account and/or the mobile wallet to a standard payment instrument (e.g., a payment card). In certain embodiments, this linking is accomplished in real time. Embodiments of the present invention are primarily targeted for use in retail point-of-sale applications where a dedicated payment instrument is issued to a merchant to enable mobile payments on standard payment terminals (e.g. POS terminals that are not otherwise provisioned to accept mobile payments) without the need for any special hardware or software. Embodiments of the present invention will also be used in connection with a consumer user's own standard payment instrument to increase payment flexibility and fraud protection.

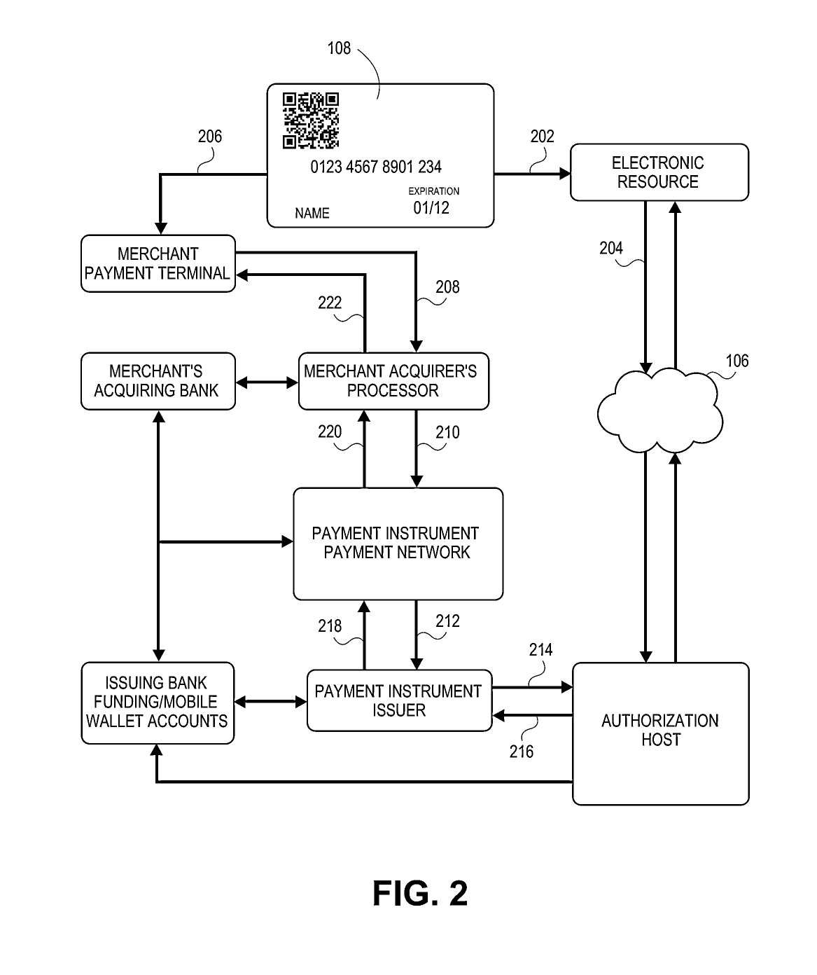

Referring to FIG. 2, an embodiment of a payment process flow according to the present inventive concept is shown and described. In the embodiment shown in FIG. 2, a system of the inventive concept includes three (3) primary components:

1. The payment instrument 108 of the inventive concept;

2. A computing device 104 capable of accessing an electronic resource of the inventive concept (i.e., the mobile app or website); and

3. An authorization host that is in communications with the computing device 104. In certain embodiments, the authorization host is embodied as one or more server devices 102.

As illustrated in FIG. 2, a merchant is issued a payment instrument 108 (in the form of a payment card with an encoded magnetic stripe) for each of its payment terminals. Each payment card includes an identification code, such as a bar code, two-dimensional QR code, a unique identification number, or other or the like, which associates the payment card with the specific merchant and the specific payment terminal to which it is issued. In some embodiments, the relationship between the identification code, the associated merchant, and the associated payment terminal are stored in a server device 102, or associated database, accessible by the authorization host.

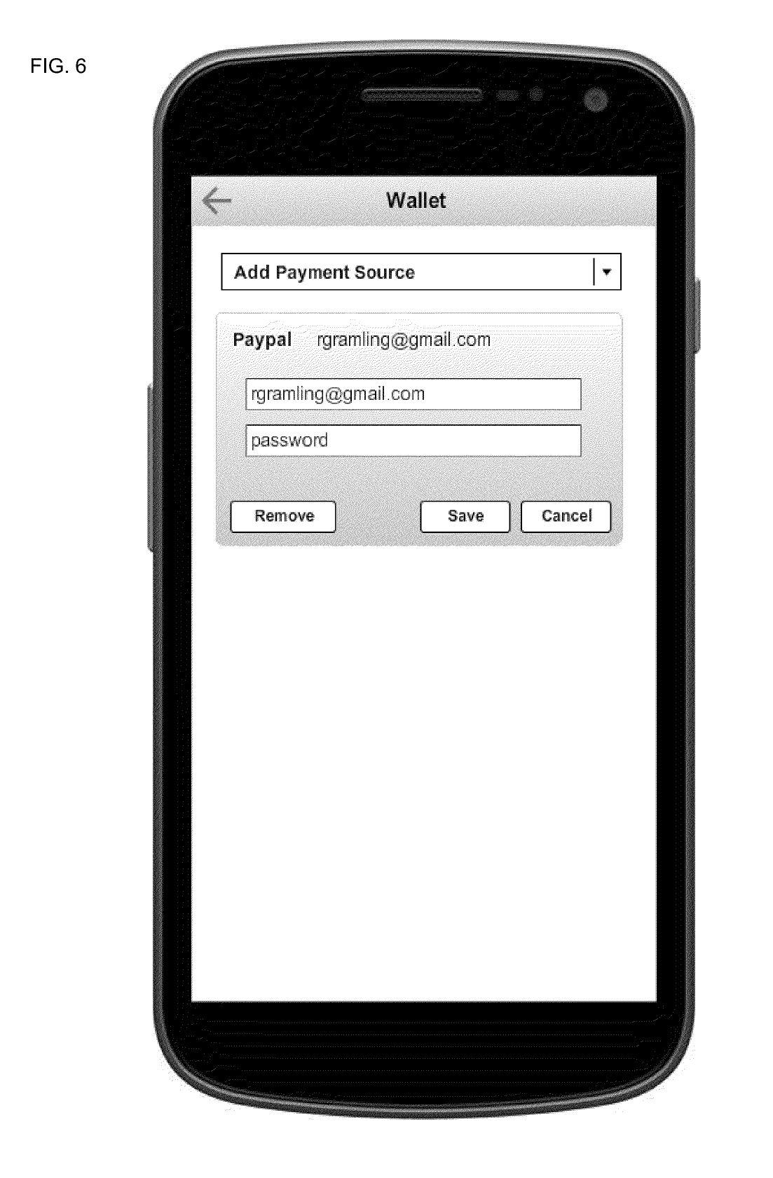

Referring to FIGS. 4 through 11 as an illustrative example of embodiments of the present invention, a consumer user approaches a payment terminal of a merchant to make a payment (this could be any type of transaction or purchase of goods or services). The consumer user accesses the electronic resource, via the mobile app or website, through his or her computing device 104 (e.g., a smartphone). Embodiments of the present invention generate a user interface on the display of the computing device 104 and request that the consumer user enter authorization information (see e.g. FIG. 4). In some embodiments, a portion of the authorization information will be the consumer user's password/PIN, which is used to verify the consumer user's identity and/or to confirm the consumer user's authorization to make the payment. In some embodiments, the password/PIN is stored locally on the mobile device. In other embodiments, the password/PIN is stored in a server device 102, such as the authorization host database, which is separate from the computing device 104. In still other embodiments, the password/PIN is stored both locally and in the authorization host database.

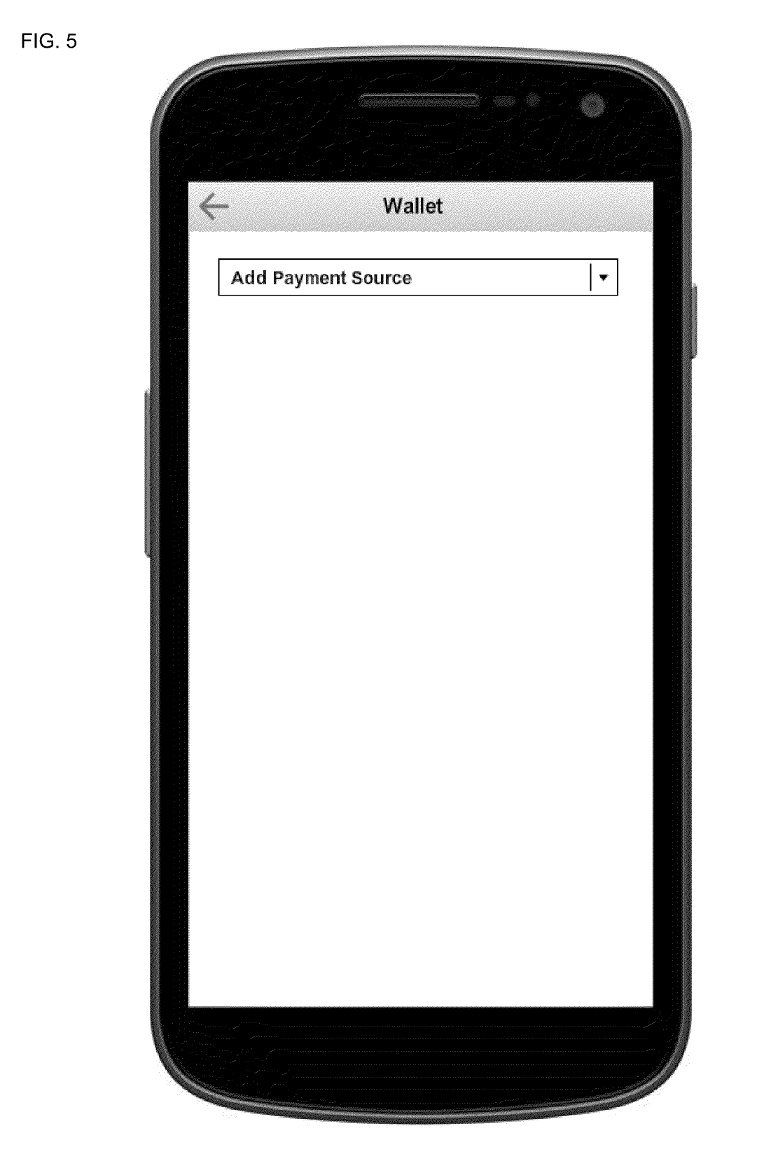

Referring to FIGS. 5-7, in some embodiments of the instant invention the consumer user is allowed to associate specific funding accounts/payment sources with the electronic resource. As is shown in FIGS. 5-7, information, such as account login ID or identification/card number, password, security code, etc., in a preferred embodiment are stored in the mobile “app” by the consumer user in association with each payment source for later access. It will be appreciated that in some embodiments, information or portions of information regarding the funding accounts will be stored in a database accessible by the authorization host. Nevertheless, in preferred embodiments, at least the list of funding accounts is stored in memory or other data storage location directly accessible by the mobile “app”, rather than requiring the mobile “app” to communicate with the transaction host to obtain a list of funding accounts. The consumer user then selects the desired payment source from a list of initiation options when the user desires to initiate a payment transaction.

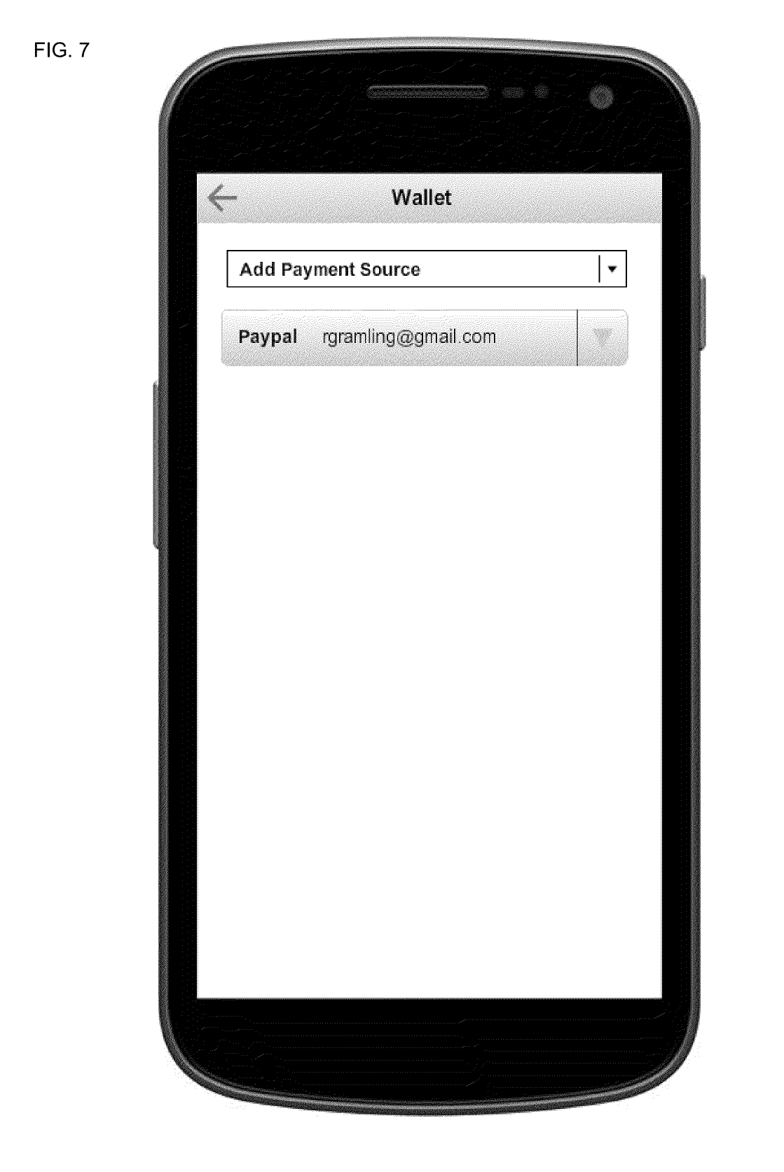

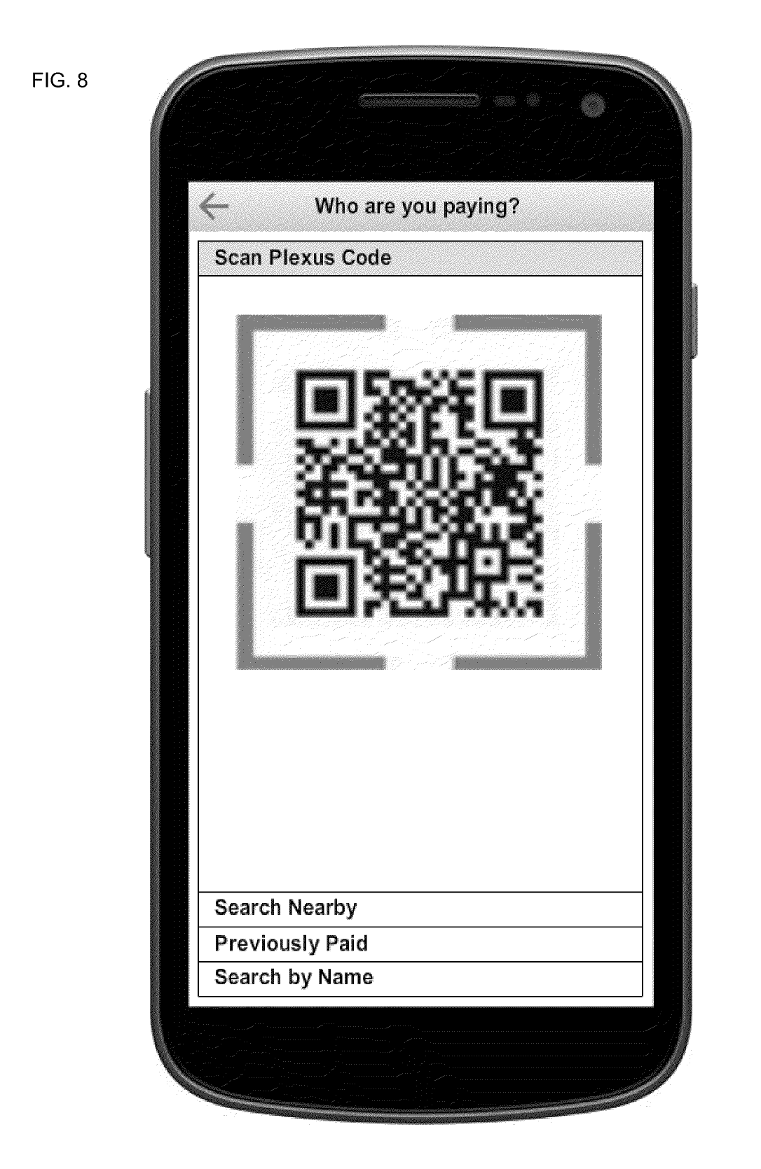

Once the consumer user has accessed the electronic resource and has verified her identity/authorization via the password/PIN, the consumer user is required to, in some embodiments, enter additional authorization information. For example, in some embodiments, a payment initiation button will be displayed via the display of the user's computing device 104. In some embodiments, such as the embodiment of FIG. 7, the payment initiation button is provided as an option to select from one or more payment sources that have been authorized for use through the electronic resource to complete payment transactions. To further authorize an initiation of the payment, the consumer user will press, or otherwise select, the payment initiation button (or desired payment source selection) to confirm the initiation of the payment process. Furthermore, in certain embodiments (including that shown in FIGS. 2 and 8), the consumer user will be provided the option to capture the payment instrument's 108 identification code. In some such embodiments, the collected identification code will be included in the authorization information. Remaining with the current example, the consumer user will be provided the option (Step 202) to capture, via the computing device's 104 optical device (e.g., digital camera), an image of the payment instrument's 108 identification code (in the embodiment shown in FIGS. 2 and 8, a two dimensional QR code). In other embodiments, including that shown in FIG. 8, the keypad or other input resource of the computing device 104 is utilized to input the identification code manually, such as: through searching for nearby locations utilizing GPS or other location tracking resources of the computing device 104 in which payment can be received via the mobile resource; selecting from a data log storing previous locations from which the particular computing device 104 has been utilized to make payment utilizing the mobile resource; or searching a database containing locations in which payment can be received via the mobile resource by inputting a location name to search into the computing device 104. It will be appreciated that other functionable inputs, or a combination of multiple functionable inputs may and will be utilized in connection with various embodiments of the inventive concept for the computing device 104 to obtain the payment instrument's 108 identification code. For example, in still further embodiments, the merchant will have an audio output device that is capable of outputting an audio signal (which may or may not be of a frequency that is audible to humans) that is received by a microphone of the computing device 104. In some embodiments, the audio signal is a high frequency audio signal. The audio signal will be associated with and converted by the computing device 104 into the identification code of the payment instrument 108. Alternatively, in some embodiments the merchant will have a Bluetooth™ enabled device, NFC, or other suitable radio frequency transmitter/receiver that transmits the identification code of the payment instrument 108 to the computing device 104. It will be appreciated that in some further embodiments, the payment instrument's 108 identification code is transmitted or otherwise provided to the computing device 104 via hardware or other mechanism that is separate from the payment instrument 108 itself. For example, in some embodiments, the identification code is transmitted from the POS terminal, or other hardware located proximate to the POS terminal.

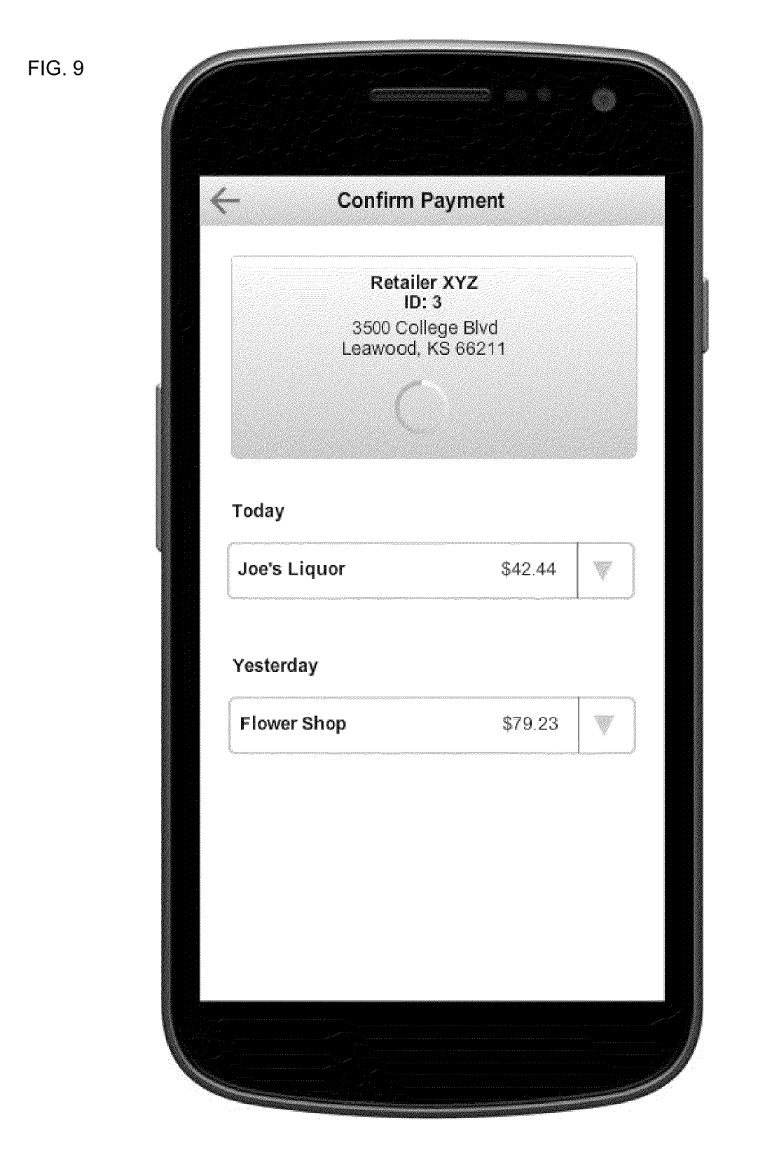

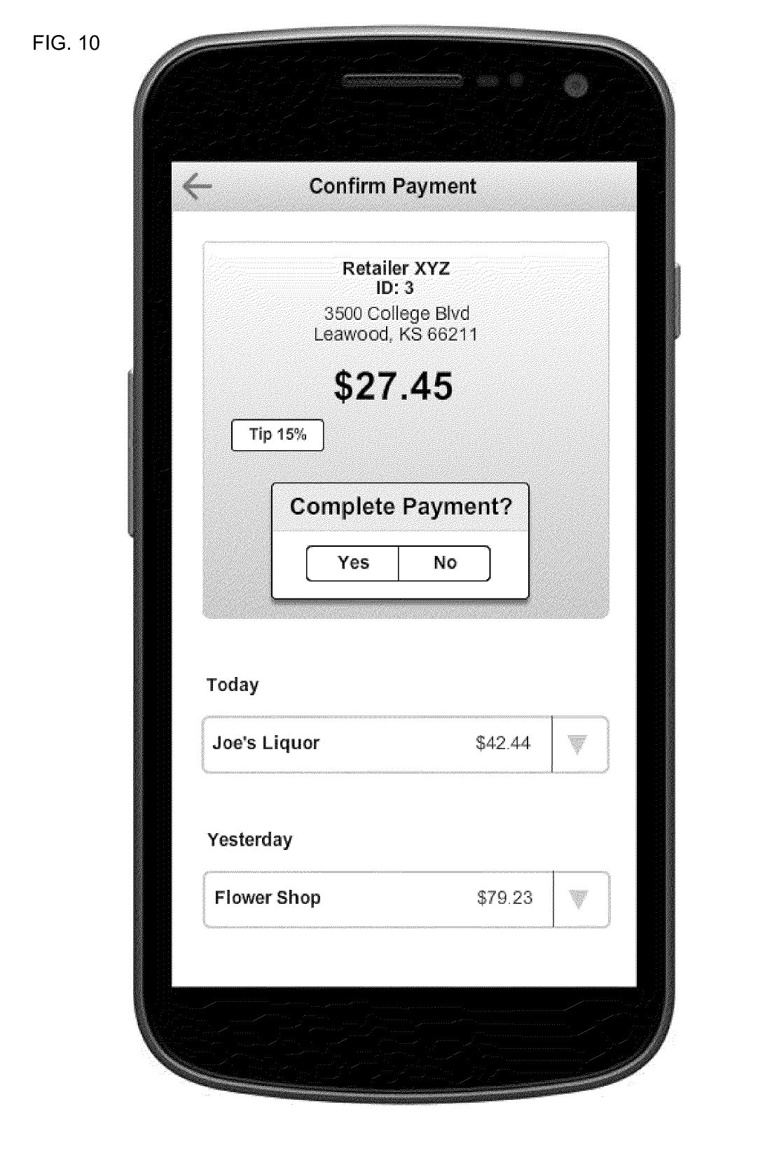

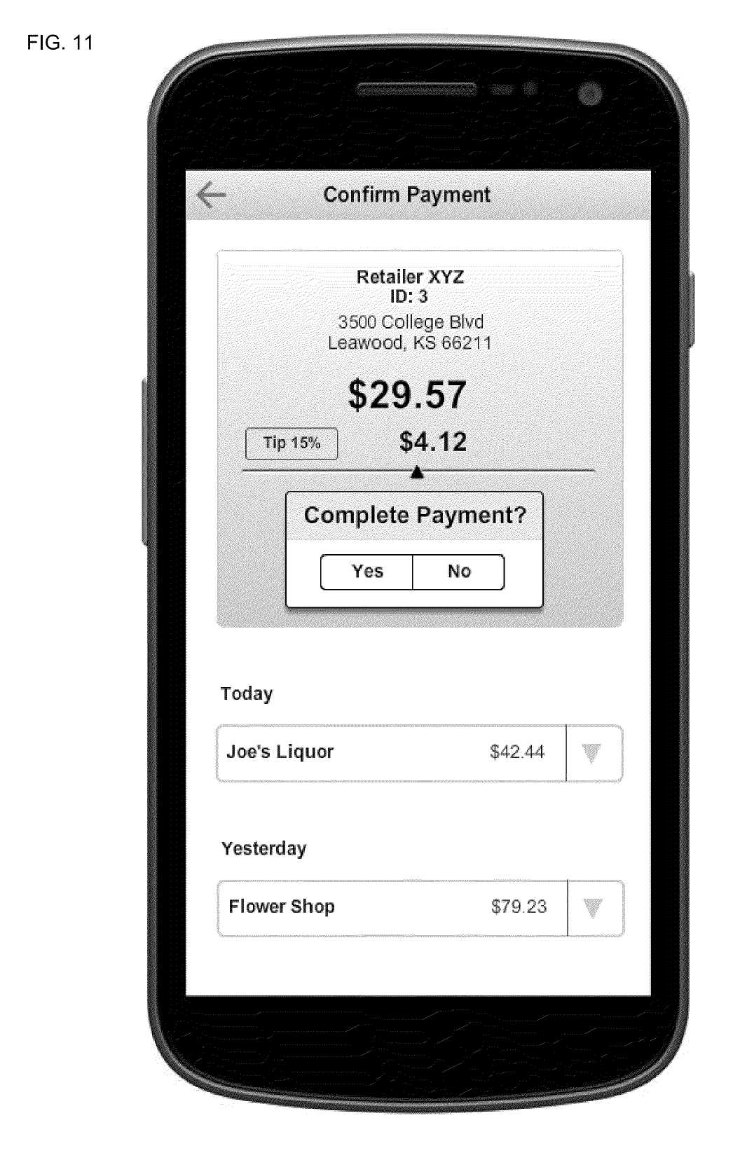

Thereafter, the consumer user finalizes the authorization of the payment, including authorizing the amount of payment and the merchant and/or specific merchant payment terminal at which the payment is to be transacted. In some embodiments, the consumer user first authorizes the payment amount by entering into the mobile resource a maximum payment amount that is allowed for the payment transaction, before the merchant/terminal is utilized to communication the payment transaction information, in the manner discussed below, to the authorization host. Alternatively, or in addition, the consumer user can simply press a displayed “Authorize” button on the display of the communication's device 104 without specifying an amount. Once all of the requested authorization information has been entered by the consumer user and received via embodiments of the present invention, such authorization information is used by embodiments of the present invention to identify the merchant payment terminal at which the payment is to be transacted, and to further authorize the payment. In more detail, the electronic resource facilitates communication, via the communications network 106, with the authorization host to provide the authorization host the authorization information (Step 204). Referring to FIGS. 9 through 11, in other embodiments, the merchant payment terminal at which the payment is to be transacted is determined utilizing the identification code before the consumer user authorizes the payment amount (see e.g. FIG. 9, identification of merchant payment terminal). This allows the consumer user to validate the payment transaction amount, after it is provided to the authorization host via the merchant's payment terminal in the manner discussed below, and before the authorization host confirms the payment transaction (see e.g. FIGS. 10 and 11). This is particularly convenient in the case of purchases at merchant locations in which it is desirable to add a tip, as it allows the consumer user to add in the tip amount via the electronic resource. In some embodiments, the electronic resource provides the consumer user an option to select a tip amount. In some embodiments, the option includes an automated tip calculator such as the tip option button shown in FIGS. 10 and 11 that automatically adds a tip in an amount of 15% of the transaction total upon selection by the consumer user. In some such embodiments, the tip amount is a predetermined fixed percentage. In other embodiments, the percentage is preset by the consumer user via a setup or preferences menu for the electronic resource. In still other embodiments, the consumer user is provided an option to manually select a tip amount or tip percentage at the time the user confirms the payment transaction.

After receiving the authorization information, the authorization host temporarily links the payment card 108 to the consumer user's mobile wallet (and thus the consumer user's funding account) for a single payment authorization. In one embodiment, this is accomplished by linking an identifier for the consumer user's mobile wallet and/or funding account (e.g., bank account number) with the merchant's payment card 108 identification code in a server device 102 (or associated database) or otherwise in a temporary memory or database for use by the authorization host.

The authorization host then transmits an acknowledgement to the electronic resource (viewable via the computing device 104) indicating to the consumer user and the merchant that the link has been made and the payment transaction may proceed. Next, a store employee operating the payment terminal tenders the transaction by swiping (Step 206) the payment instrument 108 and processing the electronic transaction (e.g., swiping the payment card through a magnetic stripe reader of the cash register) by capturing payment transaction information. The payment transaction information will include payment instrument 108 information as well as other purchase specific information. For example, the purchase specific information will include a payment transaction amount, a timestamp, a merchant location, a merchant identification, or the like. The payment instrument 108 information includes the Cardholder Name, Primary Account Number or PAN, expiration date, and security code such as CV2, as previously described. Thus, as previously described, in some embodiments the merchant's payment instrument 108 is a standard payment card that includes a magnetic stripe to allow the merchant's payment terminal to read the payment instrument 108 information directly from the payment card.

In some embodiments, the payment instrument 108 information read by the payment terminal is simply the payment instrument's identification code (e.g., the QR code). In other embodiments, the payment instrument 108 information includes additional information, but is nonetheless associated with the identification code within the authorization host, as will be discussed in more detail below. For example, the payment instrument 108 information that is read by the payment terminal will, in some embodiments, include a PAN. In some embodiments the PAN will be pre-associated with the payment instrument's 108 identification code within the authorization host so as to provide a link between the payment instrument information obtained by the magnetic reader of the payment terminal and the payment instrument identification code.

As illustrated in FIG. 2, the merchant's payment terminal communicates with the authorization host via standard payment networks. For instance, the payment terminal will initially communicate with the merchant acquirer's processor in the same manner in which standard payment cards (e.g., VISA™ and MASTERCARD™ cards) are processed, and the merchant acquirer's processor routes the payment transaction information over an open loop payment network like any standard payment card transaction. Specifically, in the embodiment shown in FIG. 2, the payment transaction information, including such information as the transaction amount, the payment instrument's 108 PAN and/or identification code, or any other desired or required transaction data is transmitted electronically from the merchant's payment terminal to the merchant acquirer's processor (Step 208). Such payment transaction information is thereafter routed electronically (Step 210), via the card issuer's payment network (e.g., VISA/MASTERCARD networks), from the merchant acquirer's processor to the payment instrument 108 issuer (Step 212). In some embodiments, the payment instrument 108 issuer will simply be an issuing bank, or alternatively, will additionally include an issuing bank's processor.

The payment instrument issuer forwards the transaction request, comprised of the payment transaction information, to the authorization host (step 214). The authorization host compares the payment transaction information received from the payment terminal with the authorization information obtained from the user's computing device 104. If the payment transaction information appropriately corresponds to the authorization information, then the authorization host will preliminarily authorize the payment transaction. If the payment transaction information does not appropriately correspond to the authorization information, then the authorization host will decline the payment transaction. In more detail, the authorization host confirms that portions of the payment transaction information matches the payment instrument's 108 identification code that was captured by the user's computing device 104 and was linked to the mobile wallet. For example, if the payment transaction information captured by the payment terminal includes the payment instrument's 108 identification code, embodiments of the present invention will ensure that such identification code matches the identification code captured by the user's computing device 104 and sent to the authorization host via the electronic resource.

Thereafter, the authorization host will verify that sufficient funds to cover the payment transaction are held within the consumer user's mobile wallet (e.g. from the payment source/funding account selected by the consumer user to fund the payment transaction). If the payment transaction information is appropriately matched and satisfied, and if there is sufficient funds within the consumer user's mobile wallet, the authorization host transmits an acknowledgement to the payment instrument issuer that the payment transaction has been validated (Step 216). In other embodiments, as is discussed above, the payment transaction amount received as part of the payment transaction information by the authorization host will be sent to the consumer user's computing device 104, via the electronic resource, such that the consumer user is required validate the payment transaction amount before the authorization host will confirm the payment transaction.

In some embodiments, the authorization host will not verify the sufficiency of funds in the mobile wallet. Instead, in such embodiments, the authorization host will simply verify that the payment transaction information matches the authorization information, and the sufficiency of funds will be verified by the payment instrument issuer. Regardless of how the mobile wallet funds are verified, the payment instrument issuer will in turn transmit an authorization code, via the payment network (Step 218), to the merchant acquirer's processor (Step 220), and the merchant acquirer's processor sends authorization for the payment transaction back to the merchant's payment terminal (Step 222). With the payment transaction confirmed, the consumer user's receipt is printed from the merchant's payment terminal and, in the embodiment shown, an electronic payment confirmation is sent to the computing device 104 from the authorization host.

The funds for the transaction are then electronically transferred from the consumer user's funding account to the merchant's acquiring bank account through the payment instrument issuer's payment network. In some embodiments this is accomplished through a daily batch process in which a merchant submits all payment transaction information for transactions that have been authorized throughout the day to the merchant acquirer's processor in one batch. The batch is sent through the payment network for distribution to the appropriate payment instrument issuer(s), and payment is routed through the payment network to the acquiring bank. In the embodiment shown, before payment is routed from the consumer user's issuing bank funding account to the merchant's acquiring bank account, the payment instrument issuer confirms electronically with the authorization host that the transaction had been authorized. In some embodiments, the authorization host will maintain in the database accessible by the authorization host the payment transaction information for each payment transaction sufficient to make such confirmation. In some embodiments this will include the payment transaction information such as merchant card number, funding/mobile wallet account number, transaction amount, transaction time and date, and any other data necessary or desirable to make such confirmation.

Although in some embodiments information is stored in the authorization host to confirm payment transactions in the manner described above, once the payment transaction has been authorized and is completed such that the consumer user receives its purchased goods/services, no further link exists between the merchant's payment instrument 108 and the consumer's mobile wallet. Additional authorization attempts will be declined until the steps described above are performed again for another consumer user to authorize and facilitate a payment transaction.

Utilizing the embodiments of the present invention, payment transactions can be performed by various types of computing devices 104 (e.g., mobile phones, smartphones, tablets, etc.) and can be accepted at any merchant/retailer that has the ability to process standard payment instrument based electronic payments (i.e. that are not provisioned or capable of receiving payments from mobile wallets). Little to no investment is required by the retailer to participate, and the consumer experience can be very similar to that of mobile contactless (e.g. NFC).

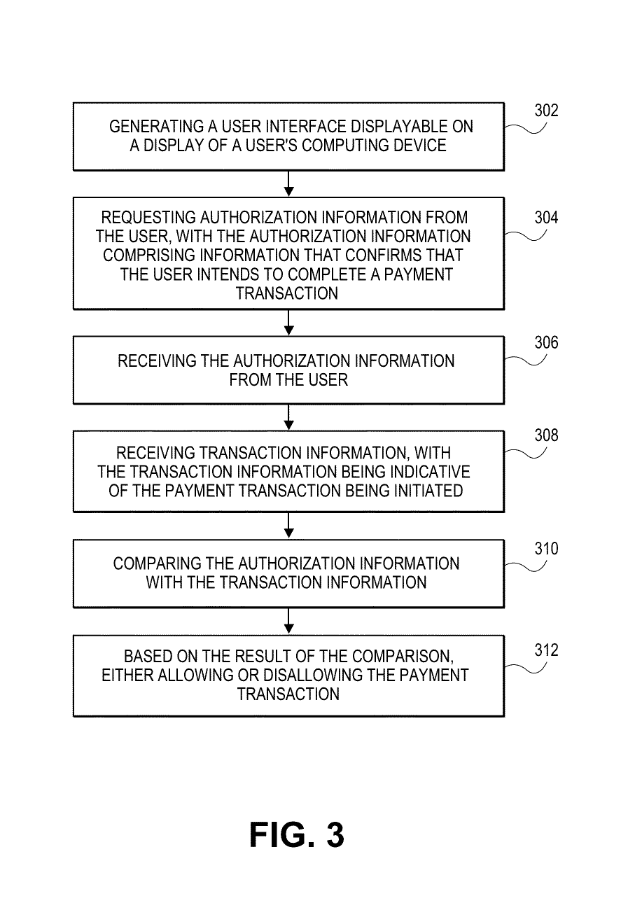

Certain embodiments of the present invention can thus be illustrated by the method shown in FIG. 3. Such embodiments include the initial Step 302 of generating a user interface displayable on a display of a computing device of a user. A next Step 304 includes requesting, via the user interface, authorization information from the user, with the authorization information comprising information that confirms that the user intends to complete a payment transaction at a payment terminal. Thereafter, in Step 306, the authorization information is received, via the user interface, from the user. In additional Step 308, transaction information is received, with the transaction information being indicative of the payment transaction being initiated at the payment terminal. Finally, the authorization information is compared with transaction information in Step 310, and in Step 312, based on the result of the comparison, the payment transaction is either allowed or declined.

In another embodiment of the present invention, a consumer user can control where and when payment transactions are authorized using a payment instrument 108 issued to, or otherwise associated with, the consumer user. In such embodiments, possession of the payment instrument 108, or the payment instrument information (e.g., the PAN), is not enough to commit fraud. Embodiments of the present invention allow a consumer user to secure the use of its payment instrument 108 by the secure password/PIN that is required to be entered by the consumer user to access the electronic resource via the computing device 104 as previously described. Additional security features of embodiments of the present invention include rules (e.g., timestamp, merchant location, merchant identification, etc.) utilized by the authorization host to verify that a particular payment transaction is properly associated with the payment instrument 108.

For enhanced security and convenience, the payment instruments 108 can be given to children, family members, or other related parties of a consumer user. Individual payments transactions can be pre-authorized by the consumer user, such that the payment instrument can be used by such parties to complete the payment transactions. For example, such pre-authorizations can be based on various rules, such as the payment transaction only being authorized for transactions of specific monetary amounts, of amounts below a particular limit, of a payment transaction performed at a particular merchant, of a payment transaction performed at a particular time, or by various other rules.

The Embodiments of the present invention described above are considered to be a form of a push type payment. Unlike traditional pull type payments where a payer provides account information to a payee who initiates an electronic payment, thus pulling funds from an account of the payer using an electronic payment network, a push type payment occurs when the payer receives account information from the payee and the payer initiates payment by authorizing funds to be sent to the payee from the payer's account. There are significant security and fraud advantages to push type payments because the payer is not required to share sensitive account information, which is therefore less prone to theft and fraud. Embodiments of the present invention can be summarized as a push type payment because the payer (or consumer user) obtains the payee (or merchant) authorization information e.g. payment instrument 108 identification code, payment terminal identifier, retailer identifier, transaction identifier, etc. and authorizes payment from the payee's funding account. The payment instrument 108 and payment network are primarily used to verify the payment transaction at the retail terminal in real time that the payer has authorized such a push payment. The authorization host manages the push payment based on the payer's authorization and the payment instrument 108 is used to authorize and capture requests. The payment network is optionally used for settlement and clearing between the merchant and the consumer user.

In other embodiments of the present invention, the embodiments described above will be modified to allow for various forms of push payments, thus permitting utilization of newer technology payment terminals (i.e. other than standard POS payment terminals with magnetic stripe readers). Some such embodiments will still include a payment terminal, but such terminal does not necessarily need to accept a standard magnetic stripe payment card (although in some embodiments, in addition to accepting payment through other technologies, the payment terminal will also accept payment through standard magnetic stripe payment cards).

For example, in the previously-described embodiments, a merchant is issued one payment instrument 108 for each of its payment terminals, and ACH payment instrument 108 includes a unique identification code (e.g., a two-dimensional QR code) that associates the payment instrument with the specific merchant and the specific payment terminal to which it is issued. In other embodiments, alternatives to the payment instrument 108 and/or identification code are utilized, including, but not necessarily limited to a global positioning system (GPS) location of the consumer's computing device 104, a GPS location history stored in a memory element of the consumer's computing device 104 (i.e. a “places I have been” file accessible by the electronic resource), etc. In such embodiments, location coordinates of the merchant's store or terminal location are stored in a server device 102, or associated database, accessible by the authorization host. The authorization host, via embodiments of the present invention, can access the consumer user's location from the computing device 104 (as provided by the GPS or as manually selected by the consumer user). Thereafter, the authorization host will compare the coordinates of the consumer user's location to those locations stored in the server device 102, or associated database, to determine and to verify the location in which the consumer user is making a payment transaction.

It will be appreciated that in some embodiments it is not necessary to identify through the electronic resource (i.e., via the consumer user's computing device 104) a specific payment terminal in which a consumer user is making or attempting to make a payment transaction. In some embodiments, the payment terminal is able to communicate directly with the authorization host and either identify or assist in identifying the consumer user's payment transaction. For example, as discussed in more detail below, embodiments of the present invention can be utilized by a consumer user that pushes payment through a “self-checkout” process, and in other embodiments through a “pay by name” process.

In embodiments of the “self-checkout” process, the computing device 104 and electronic resource are used by a consumer user to scan purchasable items offered for sale by merchants (i.e., items available on the merchant's shelves). The consumer user can then pay for such items, via the computing device 104, with the mobile wallet that is linked to the consumer user's funding account. Such embodiments can be used as an alternative to existing business models that require merchant retail stores to have checkout lanes with individual payment terminals that are manned by store employees. In such embodiments, the consumer user will create a user profile, which may include a photo of the consumer user or other identifying information. Confirmed purchases made by the consumer user via the computing device 104 are presented on a display screen accessible by the store employee who can observe customer's as they leave the merchant's retail store. In operation, the consumer user uses its computing device 104 to identify the merchant (e.g., via barcode, QR code, GPS/Map, historical “places I have been” file, etc.), to scan purchases (e.g., barcode scan, manual input, etc.), and to press a payment button on the computing device 104 to finalize payment. Confirmation of the payment transaction is as simple as displaying the consumer user's user profile on the display screen accessible by the store employee as the consumer user exits the merchant's retail store. In some embodiments, the store employee identifies the particular consumer user by photo identification. In other embodiments, the a payment terminal used by the store employee will include other technical integration with embodiments of the present invention (i.e., the authorization host) to aid in and/or automatically identify the appropriate payment transaction and to confirm payment before, or as, the consumer user is leaving the store.

In other embodiments, the “pay by name” process is specifically useful at merchants such as a quick-service restaurant (i.e., fast food, coffee shops, etc.). In such embodiments the consumer user “check's in” at a particular merchant, such as by using a GPS/Map application of the computing device 104, scanning a barcode/QR code, or otherwise identifying the merchant through use of the electronic resource via the consumer user's computing device 104. After checking in, the computing device 104 will communicate with a payment terminal or other device at the merchant's location, so as to provide an indication on the payment terminal that the consumer user is at the merchant. In some embodiments, the consumer user's computing device 104 communicates with the payment terminal via the authorization host of embodiments of the present invention. When the consumer user places an order for purchase, a store employee has a list, displayed on the payment terminal, of customer's who are at the merchant and who are authorized to make payments with their mobile wallet. The consumer user simply gives their name to the store employee and the store employee can verify by comparing the consumer user's provided name with the list, or in alternative embodiments, by comparing the consumer user's appearance with a photo of the consumer user displayed on a screen of the payment terminal. In some such embodiments, payment is initiated as a push payment from the consumer user. In other embodiments, the store employee initiates payment from the payment terminal after the consumer user has been identified through the “pay by name” process.

It will be appreciated that although in some embodiments of the present invention described above require no non-standard technical integration by the merchant, some or all of the advanced embodiments of push payments described herein require increasingly significant technical integrations by the merchant. Push-style payments in general require integration between the authorization host and payment terminal of the merchants. For example, the “pay by name” process in some embodiments will require a more integrated payment terminal that can communicate with embodiments of the present invention via Internet, WiFi, cellular, or other similar networks. In addition, the “self-checkout” process of some embodiments will require a substantial integration of merchant back-office software, price-book/inventory software, and/or other in-store system integration.

Many of the push payment embodiments operate in the same or similar manner as described above in connection with other embodiments of the present invention. Generally, a consumer user walks up to the store employee and payment terminal at the merchant location to make a payment. The consumer user launches the electronic resource on his/her computing device 104 (e.g., mobile phone) and enters a security password/PIN. A payment button is displayed and pressed in the GUI of the electronic resource to start a payment transaction, and in one embodiment the computing device's 104 camera is used to obtain/scan an image of the merchant's payment instrument 108 identification code. Once the electronic resource has identified the merchant payment terminal on which the payment transaction is to be performed, the consumer user can enter a maximum payment amount or simply press the “Authorize” button in the electronic resource. The electronic resource then communicates with the authorization host to provide the merchant's payment instrument 108 identification code, identification of the consumer's mobile wallet payment account (and any other information, such as max payment amount) to the authorization host. The authorization host temporarily links the payment instrument 108 to the consumer's funding account/mobile wallet for a single payment authorization. The authorization host then transmits an acknowledgement to the electronic resource indicating to the consumer user and the merchant that the link has been made and the payment transaction may proceed. Thereafter, the store employee tenders sale through the merchant's payment terminal. In some embodiments, the merchant's payment terminal communicates with the merchant acquirer's processor in the same manner in which standard payment cards are processed, and the merchant acquirer's processor routes the payment transaction information over an open loop payment network like any normal credit or debit card transaction to complete the payment transaction in the same or similar manner discussed above. Once the payment transaction has been authorized and is completed such that the consumer user receives its purchased goods/services, no further link exists between the merchant's payment terminal and the consumer user's mobile wallet. Additional authorization attempts will be declined until another consumer user obtains the payment instrument 108 identification code and authorizes a payment transaction.

The push payment embodiments of the inventive concept provide for increased security of payments and payment sources to consumers as well as to merchants. Consumers never have to provide a merchant with the consumer's funding account/mobile wallet information. Instead, the consumer obtains information from the merchant, via the electronic resource, which is sufficient to allow the consumer to push a payment to the merchant's bank account. Such information could simply be ACH routing information that only enables payments to be made to a merchant's bank account without allowing funds to be withdrawn from the consumer's funding account. In embodiments in which ACH or other forms of push payment systems are utilized, the open loop credit network process discussed above is not necessarily required. Instead, the payment terminal and/or the authorization host will be connected to the merchant's acquiring bank to confirm receipt of an ACH and complete the transaction with the consumer purchasing goods/services from the merchant.

In some embodiments, the authorization host mines data regarding payment transactions completed by one or more consumers and/or merchants. The mined data is then utilized for providing merchants or other parties demographic or other information regarding consumer purchasing habits and the like. In addition, in some embodiments, the mined data is utilized to provide consumer users with targeted coupons, offers or other promotions..

The foregoing and other objects are intended to be illustrative of the invention and are not meant in a limiting sense. Many possible embodiments of the invention may be made and will be readily evident upon a study of the following specification and accompanying drawings

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer-readable storage medium with a computer program for facilitating payment processing stored thereon, wherein the computer program instructs one or more processors to perform the following steps:
generate a user interface displayable on a display of a computing device of a user;
request, via the user interface, authorization information from the user, wherein the authorization information comprises information that confirms that the user intends to complete a mobile payment transaction at a payment terminal that is not otherwise provisioned to accept mobile payments;
receive the authorization information from the user;
receive a transaction information, wherein the transaction information is indicative of the payment transaction being initiated at the payment terminal;
compare the authorization information with the transaction information; and
based on the result of the comparison, either allowing or disallowing the payment transaction to be completed.

2. The non-transitory computer-readable storage medium of claim 1, wherein the computer program instructs the processor to perform the following additional steps:
upon allowing the payment transaction to be completed, initiate a withdrawal of a payment transaction amount from a funding account of the user.

3. The non-transitory computer-readable storage medium of claim 2, wherein the funding account is associated with a mobile wallet that is accessible via the user's computing device.

4. The non-transitory computer-readable storage medium of claim 1, wherein the authorization information is selected from one or more of the following: a password, a payment instrument identification code, and a payment transaction amount.

5. The non-transitory computer-readable storage medium of claim 4, wherein the payment instrument identification code is a QR code.

6. The non-transitory computer-readable storage medium of claim 1, wherein an identification code is received by the computing device, said identification code being received from one of a group selected from one or more of the following: a magnetic stripe card, an NFC device, a Bluetooth device, a radio frequency transmitting device or an audio transmitting device.

7. The non-transitory computer-readable storage medium of claim 1, wherein the transaction information is selected from one or more of the following: a payment instrument information, a payment transaction timestamp, and a payment transaction amount.

8. The non-transitory computer-readable storage medium of claim 7, wherein the payment instrument information is selected from one or more of the following: a primary account number, a payment instrument identification code, and a security code.

9. A method for facilitating payment processing, the method comprising the steps of:
providing a set of computer-executable instructions that, when executed by a computing device of a user, generates a user interface displayable on a display of the user's computing device;
requesting, via the user interface, authorization information from the user, wherein the authorization information comprises information indicative of whether the user intends to complete a payment transaction at a payment terminal that is not otherwise provisioned to accept mobile payments;
receiving, via the user interface, the authorization information from the user;
receiving a transaction information, wherein the transaction information is indicative of the payment transaction being initiated at the payment terminal;
comparing the authorization information with the transaction information; and
based on the result of the comparison, either allowing or disallowing the payment transaction to be completed.

10. The method claim 9, including the following additional steps:
upon allowing the payment transaction to be completed, initiating a withdrawal of a payment transaction amount from a funding account of the user.

11. The method of claim 10, wherein the funding account is associated with a mobile wallet that is accessible via the user's computing device.

12. The method of claim 9, wherein the authorization information is selected from one or more of the following: a password, a payment instrument identification code, and a payment transaction amount.

13. The method of claim 12, wherein the payment instrument identification code is a QR code.

14. The method of claim 9, wherein an identification code is received by the computing device, said identification code being received from one of a group selected from one or more of the following: a magnetic stripe card, an NFC device, a Bluetooth device, a radio frequency transmitting device or an audio transmitting device.

15. The method of claim 9, wherein the transaction information is selected from one or more of the following: a payment instrument information, a payment transaction timestamp, and a payment transaction amount.

16. The method of claim 15, wherein the payment instrument information is selected from one or more of the following: a primary account number, a payment instrument identification code, and a security code.

17. A system comprising:
(a) one or more memory devices; and
(b) a computer program stored on the one or more memory devices, wherein the computer program instructs one or more processors to perform the following steps:
generate a user interface displayable on a display of a computing device of a user;
request, via the user interface, authorization information from the user, wherein the authorization information comprises information that confirms that the user intends to complete a payment transaction at a payment terminal that is not otherwise provisioned to accept mobile payments;
receive, via the user interface, the authorization information from the user;
receive a transaction information, wherein the transaction information is indicative of the payment transaction being initiated at the payment terminal;
compare the authorization information with the transaction information; and
based on the result of the comparison, either allowing or disallowing the payment transaction to be completed.

18. The system of claim 17, wherein the computer program instructs the processor to perform the following additional steps:
upon allowing the payment transaction to be completed, initiate a withdrawal of a payment transaction amount from a funding account of the user.

19. The system claim 18, wherein the funding account is associated with a mobile wallet that is accessible via the user's computing device.
